(19) United States
(12) Patent Application Publication
(10) Pub. No.: US 2025/0034934 A1
(43) Pub. Date: Jan. 30, 2025

(54) PROCESS AND APPARATUS FOR THE CONSTRUCTION AND APPLICATION OF A RIGID SPACER FRAME FOR INSULATING GLASS

(71) Applicant: FOREL S.P.A. UNIPERSONALE, Roncade (Treviso) (IT)

(72) Inventors: Fortunato VIANELLO, Roncade (Treviso) (IT); Riccardo VIANELLO, Roncade (Treviso) (IT)

(21) Appl. No.: 18/689,626

(22) PCT Filed: Sep. 9, 2022
(86) PCT No.: PCT/IB2022/058501

§ 371 Date: Mar. 6, 2024

(30) Foreign Application Priority Data
Oct. 4, 2021 (IT) 102021000025355

(51) Int. Cl. E06B 3/673; E06B 3/663

(52) U.S. Cl. CPC E06B 3/67308; E06B 3/66352; E06B 3/67317; E06B 3/67321; E06B 3/67369

(57) ABSTRACT

A process for the construction and application of a rigid spacer frame for insulating glass involves preparing segments of the rigid spacer frame, applying a butyl sealant to sides of the segments facing in use glass sheets, storing the segments at a warehouse, assembling the segments to form the rigid spacer frame at an apparatus for the construction and application of the spacer frame, the apparatus having a support movable in vertical direction between a lowered assembly start position and a raised assembly end position and arranged with references for the segments. The process further involves positioning the movable support at a height so as to allow positioning of the rigid spacer frame at a surface of a glass sheet arranged on a support surface of the apparatus, and positioning the rigid spacer frame at the surface of the glass sheet.

### FIELD OF APPLICATION

The present invention relates to a process and apparatus for the construction and application of a rigid spacer frame for the production of insulating glass.

### PRIOR ART

As is known, the different types of profiles used today as spacers in the production of insulating glass may be divided into two categories: rigid spacer profiles and flexible spacer profiles.

Rigid spacer profiles are made from a metal material, typically aluminum or stainless steel, or plastics material or mixed metal/plastics, typically polycarbonate, polypropylene, etc., and stainless steel, supplied in bars of a variable length from 4 to 6 meters, which are suitable for the manufacturing of spacer frames.

Flexible spacer profiles are instead supplied wrapped in coils for manual or automatic application onto the glass sheet, or in drums if of the butyl type with thermoplastic characteristics, and heat-applied by extrusion directly onto the glass sheet.

The construction and subsequent application of the spacer frame, using rigid profiles belonging to the first category, generally involves the following steps:
1) folding the profile bars by means of a dedicated machine so as to form the shape of the desired spacer frame;
2) closing the spacer frame by means of a special joint inserted into the cavity of the two ends in order to obtain the desired frame shape;
3) inserting one or more sides of the hygroscopic material spacer frame which, in the insulating glass, will have the function of absorbing the moisture initially present within the cavity between the two glass sheets, or that subsequently penetrates therein;
4) depositing the primary sealant at the sides of the spacer profile that will subsequently come into contact with the glass sheet, generally an activity that is performed using a special semi-automatic or automatic machine;
5) transporting the spacer frame to the frame laying station of the insulating glass manufacturing line;
6) temporarily depositing the spacer frame near the insulating glass production line until the line is ready for the application of said frame to the glass sheet; and
7) manually applying the spacer frame to one of the glass sheets that will make up the insulating glass.

The first step may be replaced by the use of straight hollow profile segments, joined by means of appropriate angular and linear joints that are available on the market. The use of a special bending machine is thus avoided but manual operations are introduced that may negatively affect productivity.

If the product reaches considerable dimensions then the spacer frame construction method described above presents considerable implementation difficulties. It may in fact be said and easily understood that, in the case of dimensions greater than three meters, given the flexibility and fragility of the spacer profiles, handling and transporting these frames requires a lot of attention and, in order not to incur permanent breaks or deformations, also the collaboration of several people. These critical issues are greatly accentuated by recent construction developments regarding spacer profiles which, in order to reduce the heat transmission coefficient thereof, are built with increasingly reduced thicknesses and using materials with ever lower mechanical characteristics, such as plastics materials or mixed metal/plastics, with the consequence of reducing the rigidity of the spacer frame.

The difficult handling of these profiles is also highlighted during transportation from the bending and construction area to the area for filling with the dehydrating material and from there to the area for depositing the primary butyl sealant onto those sides that will come into contact with the glass.

Finally, the transportation to the insulating glass production line and the application to the glass also put the integrity of the frame at risk and normally require numerous people. There is often a need to deposit a frame that is ready for application near the production line while waiting for said line to finish the previous production batch: if large in size, this requirement is also not without drawbacks and risks for the integrity of the frame. Furthermore, during the glass application step, there is the additional burden of often having to operate at height, even up to four meters, due to the size of larger windows, and with the need for the operator to have to overhang due to the inclination of about 6 degrees of the glass sheets in transit on insulating glass production lines.

Italian patent application No. 102019000017270 shows a device for the construction and application of the rigid spacer frame, consisting of a template, which is used for construction on the horizontal plane, and a kinematic mechanism for positioning the frame and template assembly in an almost vertical position, and then automatically applying the frame to the glass sheet, acting with a thrust that is proportional to the dimensions of the frame itself.

This device, while solving the problems described above, is not adapted for the purpose if the glass sheet has geometric defects, an eventuality that is not unusual especially in the case of large dimensions. More precisely, in the very common case of a rectangular glass sheet which lacks orthogonality between two contiguous sides, insofar as the template and consequently the spacer frame were constructed with a perfectly orthogonal geometry, at the glass-frame coupling there will be areas of the perimeter with a distance between the spacer and the edge of the glass sheet that is too small and, vice versa, areas where this distance is excessive. The finished insulating glass product may consequently have areas with insufficient or excessive secondary sealing depth that do not therefore meet the required value.

In common practice, the spacer is manually positioned so as to obtain the greatest possible uniformity of the secondary sealant depth. This practical fix is not possible with the device and method described in the Italian patent application 102019000017270, insofar as the spacer frame construction and positioning template is rigid, and obviously designed for almost ideal situations, in the absence of defects within the geometry of the glass sheets.

Another document that addresses the problem of the difficult application of large spacer frames is the utility model DE 20 2020 001 040 U1 which, however, does not address the problem of the construction of large frames or solve the problems of the difficult handling of such frames during the steps for the application of the butyl adhesive, the insertion of the hygroscopic material and transportation to the production line.

WO 2020/015864 also proposes a solution for the precise positioning of the spacer frame while, as in the previous case, ignoring those problems relating to the construction, handling and transportation to the glass application station.

### DISCLOSURE OF THE INVENTION

The need to solve the drawbacks and limitations mentioned with reference to the prior art is therefore felt.

The need is therefore felt to provide a process and an apparatus that allow for the construction and subsequent positioning of a rigid spacer frame on a glass sheet, even in cases where the glass sheet has geometric defects, such as the non-perfectly orthogonal geometry of two contiguous sides.

This requirement is met by a process for the construction and application of a rigid spacer frame according to claim 1, and by an apparatus for the construction and application of a rigid spacer frame according to claim 13.

### DESCRIPTION OF THE DRAWINGS

Further features and advantages of this invention will become more apparent from the following detailed description of preferred, non-limiting embodiments thereof, in which:

FIG. 1 shows, in schematic form, a top plan view of a possible embodiment of an insulating glass production line comprising an apparatus for the construction and application of a rigid spacer frame;

FIG. 2 shows, in schematic form, a possible embodiment of a portion of an apparatus for the construction and application of a rigid spacer frame;

FIGS. 3 to 5 show, in schematic form, a possible embodiment of a portion of an apparatus for the construction and application of a rigid spacer frame, in successive steps of a process according to the present invention;

FIG. 6 shows, in schematic form, an enlarged detail of the apparatus in FIG. 5;

FIG. 7 shows, in schematic form, the enlarged detail of the apparatus of FIG. 6, at a subsequent step of the process according to the present invention;

FIG. 8 shows, in schematic form, a possible embodiment of a lower portion of the apparatus for the construction and application of a rigid spacer frame;

FIG. 9 shows, in schematic form, a possible embodiment of a portion of an apparatus for the construction and application of a rigid spacer frame;

FIG. 10 shows, in schematic form, a possible embodiment of a portion of an apparatus for the construction and application of a rigid spacer frame; and

FIG. 11 shows, in schematic form, a possible embodiment of a portion of an apparatus for the construction and application of a rigid spacer frame.

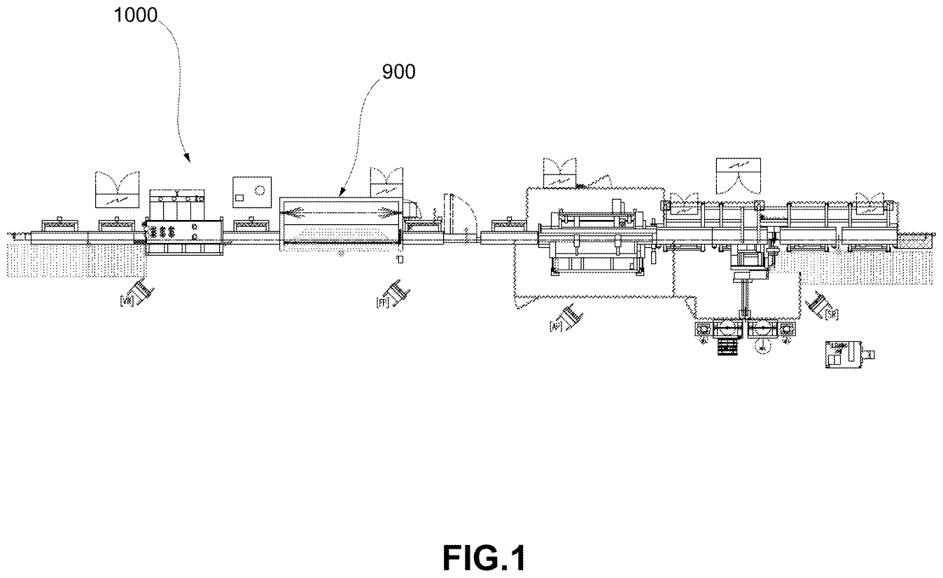

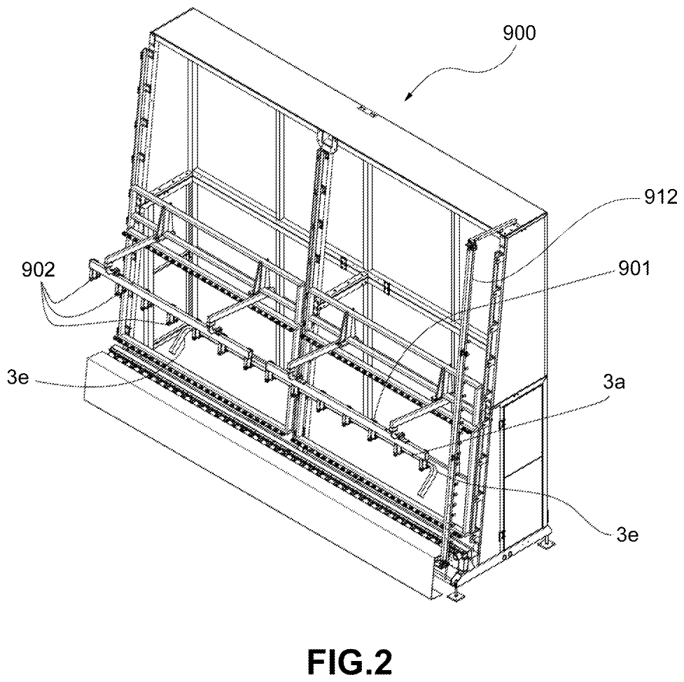

Elements or parts of elements common to the embodiments described hereinafter will be indicated with the same numerical references.

### DETAILED DESCRIPTION

The process for the construction and application of a rigid spacer frame 3 for insulating glass essentially comprises the following steps:
a) preparing segments 3a, 3b, 3c, 3d, 3e of a rigid spacer frame 3;
b) applying a butyl sealant at the sides of the segments 3a, 3b, 3c, 3d, 3e that are intended, in use, to be facing the glass sheets 2, which sealant is adapted for realizing the primary sealant of the insulating glass;
c) storing the segments 3a, 3b, 3c, 3d, 3e at a warehouse 910;
d) assembling the segments 3a, 3b, 3c, 3d, 3e in order to form the spacer frame 3 at an apparatus 900 for the construction and application of a spacer frame 3, the apparatus 900 comprising a support 901 which may be moved in the vertical direction between a lowered assembly start position and a raised assembly end position, the movable support 901 being arranged with references 903 for the segments 3a;
e) positioning the movable support 901 at a height so as to allow for the positioning of the spacer frame 3 at a surface of a first glass sheet 2 arranged on a support surface 909 of the apparatus 900;
f) positioning the spacer frame 3 at a surface of the first glass sheet 2.

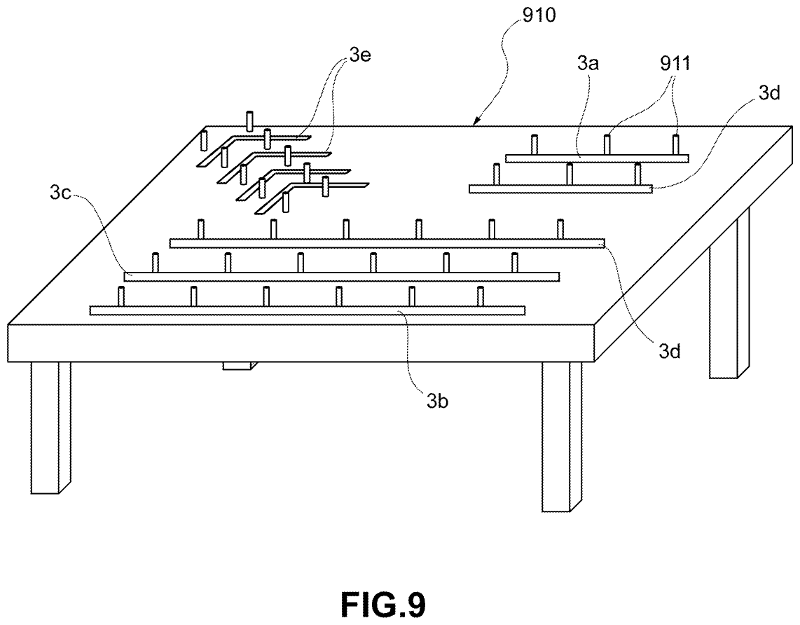

Step a) for preparing the segments 3a, 3b, 3c, 3d, 3e of the rigid spacer frame 3 may comprise preparing straight segments 3a, 3b, 3c, 3d and possibly angular segments 3e. Examples of such segments are shown in FIG. 9.

Furthermore, step a) for preparing the segments 3a, 3b, 3c, 3d of the rigid spacer frame 3 may comprise a step of filling with (hygroscopic) desiccant material and closing the ends with the insertion of caps, preferably made of rubber or sponge, or by means of respective angular sections 3e. This procedure is of a type known per se, and will therefore not be further elaborated upon.

The segments 3a, 3b, 3c, 3d, 3e may have an extension which is straight, curved, or angular with an angle of about 90° and/or with an angle greater than or less than 90°.

Again, with reference to FIG. 9, the step c) of depositing the segments 3a, 3b, 3c, 3d, 3e at a warehouse 910 may occur on a horizontal or vertical rack, arranged with separating pegs 911 in non-stick material, which pegs are adapted to avoid contact and accidental adhesion between the segments 3a, 3b, 3c, 3d, 3e.

The rack may, for example, be a table with a horizontal support surface whereupon the separating pegs are arranged.

According to a possible embodiment, before step d) a step may be included for lowering the movable support 901 to such a height to allow an operator to position the segments 3a, 3b, 3c, 3d, 3e.

In this regard, the movable support may be a substantially horizontal bar provided with support elements 902 and movable pegs 905.

The support elements 902 are elements intended to support the upper horizontal section of the spacer frame 3, i.e. the horizontal segment 3a.

The movable pegs 905 are adapted to be moved between a first position in which they do not allow a segment to slide from the support elements 902 towards a support surface 909 for a glass sheet 2 of the apparatus 900, and a second position in which they allow a segment to slide from the support elements 902 towards the support surface 909.

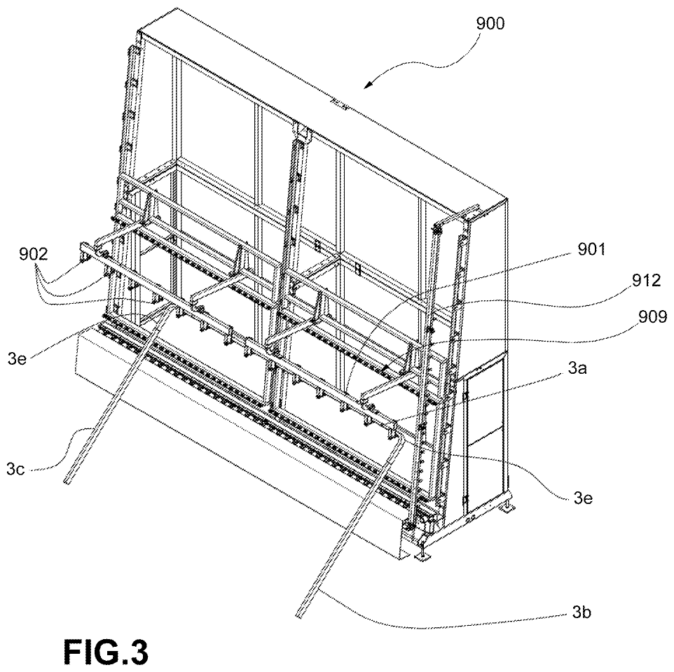

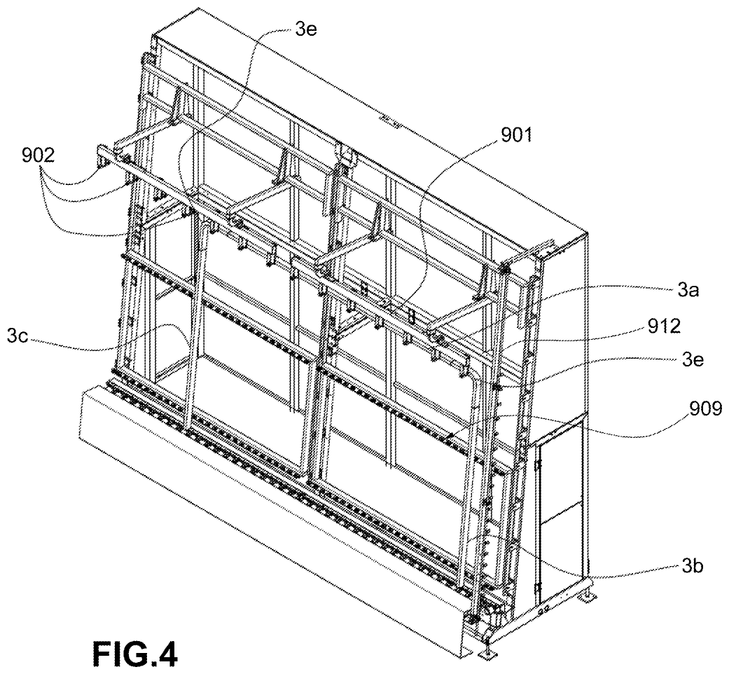

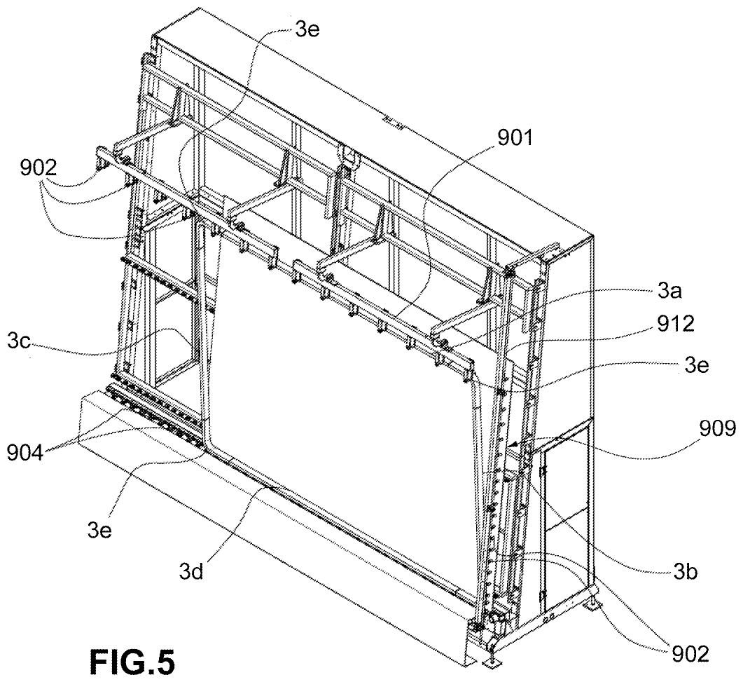

The support surface 909 may be defined by a support frame as seen for example in FIGS. 3-6.

According to a possible embodiment, the movable pegs 905 may be substantially L-shaped elements that are adapted to be rotated between the first position and the second position.

The means used for the movement of the movable pegs 905 may be of a type known per se, such as linear or rotary actuators, that may be actioned by means of a control unit.

Advantageously, the movable pegs 905 may be a plurality and may be arranged at substantially regular intervals along the length of the movable support.

Advantageously, the apparatus 900 may comprise a row of lower references 904 for the spacer frame 3, and lower pegs 906 that may be moved between a first position in which they do not allow the sliding of the spacer frame 3 towards the support surface 909 for said glass sheet 2 and a second position in which they allow the sliding of the spacer frame 3 towards the support surface 909.

According to a possible embodiment, the movable pegs 906 may be substantially L-shaped elements that are adapted to be rotated between the first position and the second position.

The means used for moving the movable pegs 906 may be of a type known per se, such as linear or rotary actuators, that may be actioned by means of a control unit.

Advantageously, the movable pegs 906 may form a plurality and may be arranged at substantially regular intervals along the length of the movable support.

According to a possible embodiment, step d) may comprise the following steps:
positioning a horizontal segment 3a, complete with angular segments 3e at the ends thereof;
possibly raising the movable support 901;
coupling vertical segments 3b, 3c;
raising the movable support 901;
coupling the ends of the vertical segments 3b, 3c with angular segments 3e; and
coupling the angular segments 3e that were just coupled to a lower segment 3d.

According to a possible alternative embodiment, if the choice is made to position the upper horizontal segment 3a without the angular segments 3e, the insertion of the same may be performed before the positioning of the vertical segments 3b and 3c and the subsequent raising of the movable support 901.

Similarly, the lower angular segments 3e may also be inserted after they have already been assembled with the lower segment 3d (or those segments that have already been assembled).

That described may be performed by two operators with the aid of suitable means for operating at heights that may also be higher than two meters.

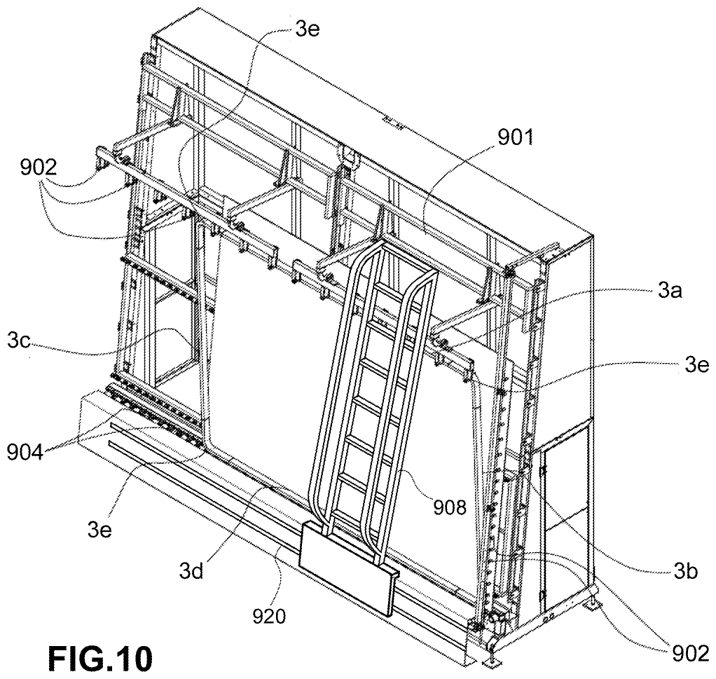

As seen in FIG. 10, the apparatus 900 may comprise a ladder 908, for example a stepladder. The ladder 908 may be movable along a direction parallel to the support surface 909. Advantageously, the ladder may be manually controlled or motorized and arranged on a track 920 parallel to the production line.

Advantageously, the ladder 908 may be tilted parallel to the support surface 909 of the apparatus 900, so as to offer the operator an ergonomic and safe working position.

According to a possible embodiment, before step f) a step is included in which the vertical references 903 and lower references (904) are positioned so as to define a determined secondary sealing depth.

Advantageously, the positioning of the vertical references 903 and the lower references 904 may be performed automatically by means of handling means connected to a control unit.

According to a possible embodiment, the vertical references 903 and the horizontal references 904 may be substantially cylindrical elements, used as references for positioning the spacer frame.

The vertical references 903 and the horizontal references 904 may be arranged on respective support bars 912, 913 that are movable by means of handling means. Such handling means may be of a type known per se to a person skilled in the art, and will not therefore be described further.

According to a possible embodiment, step f) may be performed manually by at least one operator, and comprises a step of verification, by at least one operator, preferably at least two operators, of the correct positioning and correct dimensions of the spacer frame 3, in relation to the real dimensions of the glass sheet 2 on which it is to be applied, and possible correction of anomalies found by means of handling, for example with remote manual control, of the lower references 904, the vertical references 903 and the movable support 901.

Advantageously, the lower references 904, the vertical references 903 and the movable support 901 may be operatively connected to the same control unit, with which an operator may interact by means of a remote control.

Step f) therefore provides for pressing against the glass sheet 2 and adhering to the glass itself by means of the butyl already applied to the segments 3a, 3b, 3c, 3d, 3e. This operation may commence from the lower side and proceed in succession insofar as the operator may have a manual remote control unit available, allowing the operator to lower the pegs of the lower references 906 one by one in succession, step by step as the operator proceeds along the lower side of the spacer frame. It is then a case of proceeding along the vertical side where the references 903 of the vertical reference bar are located. After the latter has been completed, it is a case of proceeding with the upper section, from the angle corresponding to the previously applied vertical section and continuing in succession, again with the possibility for the operator to gradually lower the pegs 905 of the upper reference bar one by one, step by step as the operator proceeds along the upper section. The process then concludes with the application of the second vertical section.

According to a further embodiment, the process anticipates a first operator who is responsible for applying the upper segment (after having already worked on the lower section and on a vertical segment), while a second operator proceeds with the application of the vertical segment which is not yet positioned, starting from the bottom and arriving at the upper corner more or less simultaneously with the positioning of the upper side, as performed by the first operator.

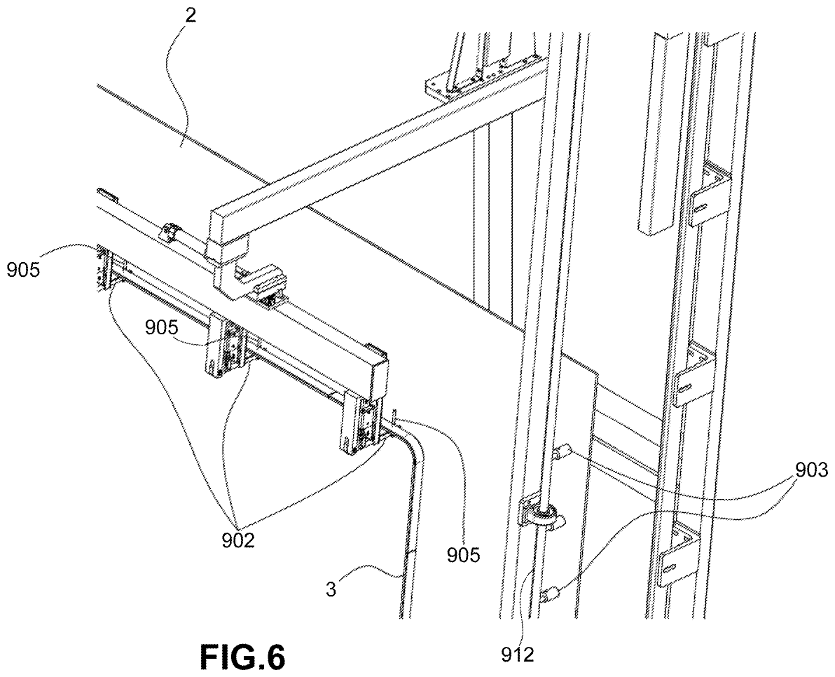

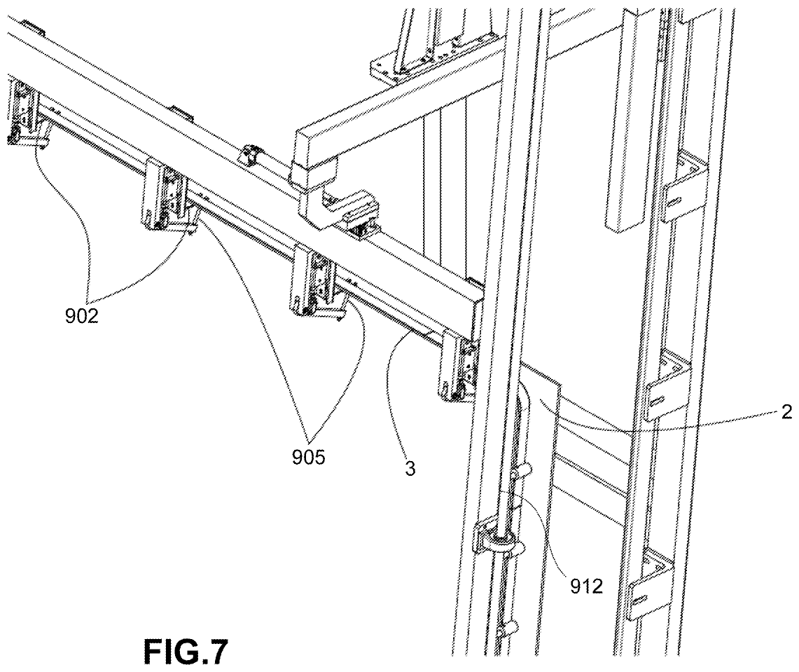

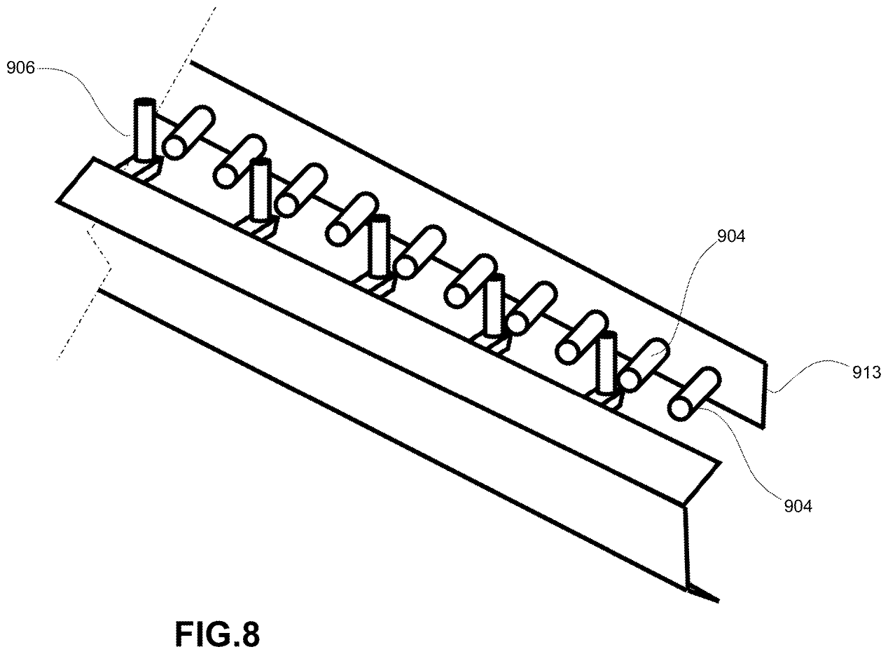

The apparatus 900 for the construction and application of a rigid spacer frame thus comprises a support 901 which may be moved in the vertical direction between a lowered assembly start position and a raised assembly end position. As may be seen in FIG. 6, the movable support is provided with references 902 for the segments 3a.

The apparatus also comprises a warehouse 910 adapted to store spacer frame segments 3a, 3b, 3c, 3d, 3e on whose sides intended in use to be facing the glass sheets 2 a butyl sealant has been applied.

As may be seen in FIG. 9, the warehouse 910 may be arranged with a horizontal or vertical rack, arranged with separating pegs 911 in non-stick material. The separating pegs 911 are adapted to avoid contact and accidental adhesion between the segments 3a, 3b, 3c, 3d, 3e.

As previously mentioned, the movable support 901 comprises support elements 902 and pegs 905 that are movable between a first position in which they do not allow a segment to slide from the support elements 902 towards a support surface 909 adapted to support a glass sheet 2 and a second position in which they allow a segment to slide from the support elements 902 towards the support surface 909.

The support elements 902 may have a support surface that is substantially perpendicular to said support surface 909.

In accordance with a possible embodiment, step a) of the procedure may comprise the application of an anti-adhesive protective film 801 on at least one of the sides of the spacer segments 3a, 3b, 3c, 3d and 3e, after these have been sprinkled with butyl. Said film 801 prevents the butyl from coming into contact with other objects or with the glass at the wrong time and when not in the required position.

In this regard, the application of this protective film 801 may be performed automatically by the same machine 800 that is used for depositing the butyl and subsequently to such an operation.

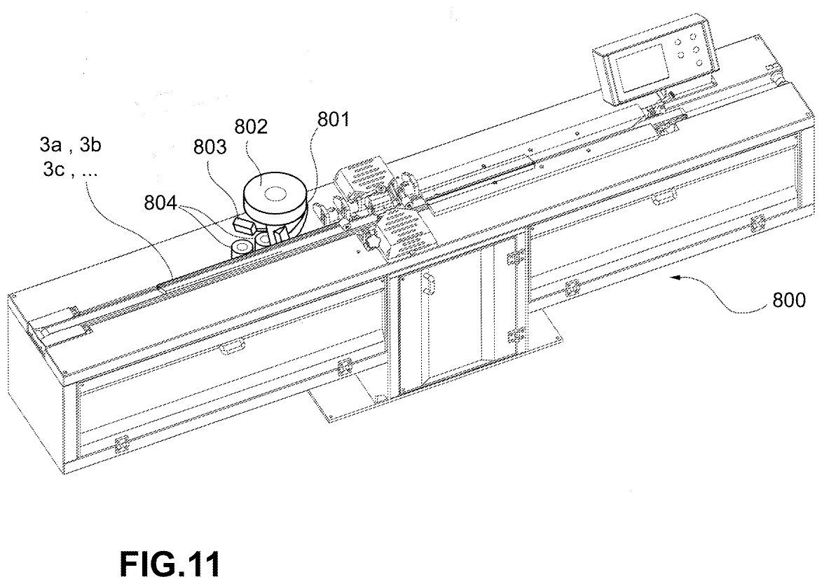

As may be seen in FIG. 11, the machine 800 of the apparatus 900 may comprise:
a cutting device 803 for custom cutting the exact length of film 801 to be applied based on the size of the spacer segment 3a, 3b, 3c, 3d or 3e being processed;
a pair of opposed rollers 804 adapted to position and adhere the film 801 to the butyl; and
at least one reel 802 of protective film 801.

By virtue of the machine 800, it is possible to avoid the use of the movable support pegs 905 and 906, respectively, of the movable support and the lower references in order to keep the spacer frame separate from the glass, until the moment of application. The removal of the film 801 may be performed manually, and over short stretches, just before adhering the spacer frame 3 to the glass with the aid of the lower, lateral and upper references.

The advantages that may be achieved with the process and apparatus of the present invention are therefore now apparent.

For example, the process and apparatus make it possible for operators to enact the appropriate minimum corrections to the ideal position of the spacer frame 3 on the glass sheet 2, so as to accommodate and correct any geometric errors in the glass sheets and to safeguard the important characteristics of the finished product, namely the depth of the secondary sealing and the final aesthetic result.

As already specified above, the procedure described hereinafter is particularly useful in the case of considerable spacer frame dimensions (for example greater than 2.5-3 m), namely when the transportation and application of the frame become difficult and risky for the integrity of the product itself.

One of the specific features of the process according to the present invention consists in constructing the spacer frame directly on the insulating glass production line, using spacer segments (straight and angular sections) that have previously been prepared, by means of the special installation station for the spacer as suitably modified for the purpose. The need therefore to transport the spacer frame from the construction area to the line and to deposit it while waiting for the appropriate moment for the application thereof is eliminated. By eliminating these last two operations, the relative risks of damage are eliminated and the quality of the finished product and the efficiency of the process are improved.

From an overview of a typical insulating glass production line of the prior art that uses a rigid spacer, it is evident that the step for the application of said spacer to the insulating glass is the only step that has not yet found a valid automated or at least semi-automated solution that makes the activity of the operator, or operators, ergonomic and safe, ensuring the quality of the finished product.

It is true that those lines that adopt spacers which are flexible or made of a thermoplastic material, which are automatically applied to the glass sheet by machines that have been developed for many years by various manufacturers, do not seem to be able, even years after the introduction thereof onto the market, to replace, for various considerations known to a person skilled in the art, rigid spacers, especially of large dimensions; this is a specific field that the present invention addresses.

Those skilled in the art will be able to make modifications to the embodiments described above or substitute described elements with equivalent elements, in order to satisfy particular requirements, without departing from the scope of the accompanying claims.

What is claimed is:

1. A process for the construction and application of a rigid spacer frame for insulating glass, comprising the steps of:
a) preparing segments of the rigid spacer frame;
b) applying a butyl sealant at sides of said segments intended in use to be facing glass sheets, adapted to realize a primary sealant of the insulating glass;
c) storing said segments at a warehouse;
d) assembling said segments to form said rigid spacer frame by means of and at an apparatus for the construction and application of the rigid spacer frame, said apparatus comprising a movable support adapted to be moved in a vertical direction between a lowered assembly start position, and a raised assembly end position, said movable support being arranged with references for said segments;
e) positioning the movable support at a height such as to allow positioning of said rigid spacer frame at a surface of a glass sheet arranged on a support surface of said apparatus; and
f) positioning said rigid spacer frame at the surface of said glass sheet.

2. The process of claim 1, wherein step a) of preparing the segments of the rigid spacer frame comprises preparing straight segments and possibly angular segments.

3. The process of claim 2, wherein step a) of preparing the straight segments of the rigid spacer frame comprises a step of filling with a hygroscopic desiccant material and closing ends by caps, the caps optionally being of rubber or sponge, or by respective angular segments.

4. The process of claim 1, wherein the segments have an extension straight, curved, or angular with an angle of about 90°, and/or with an angle greater than or less than 90°.

5. The process of claim 1, wherein step a) comprises applying an anti-adhesive protective film on at least one of the sides of the segments, after the segments have been sprinkled with butyl.

6. The process of claim 1, wherein step c) of storing said segments at the warehouse occurs on a horizontal or vertical rack, arranged with separating pegs of non-stick material, said separating pegs being adapted to avoid contact and accidental adhesion between the segments.

7. The process of claim 1, wherein before step d), the process comprises a step is included of lowering the movable support to a height such as to allow an operator to position the segments.

8. The process of claim 1, wherein said movable support comprises support elements and movable pegs adapted to be moved between a first position in which the movable pegs do not allow a segment to slide from the support elements towards the support surface and a second position in which the movable pegs allow the segment to slide from the support elements towards the support surface.

9. The process of claim 1, wherein step d) comprises a step of positioning a horizontal segment complete with angular segments at ends thereof, possibly raising the movable support, coupling vertical segments, raising the movable support, coupling ends of the vertical segments with the angular segments and coupling the angular segments just coupled with a lower segment.

10. The process of claim 1, wherein before step f), the process comprises a step of positioning vertical references and lower references so as to define a determined secondary sealing depth.

11. The process of claim 10, wherein the step of positioning the vertical references and the lower references is performed automatically by handling means connected to a control unit.

12. The process of claim 10, wherein step f) is performed manually by at least one operator, and comprises a step of verifying by the at least one operator, correct positioning and correct dimensions of the rigid spacer frame, in relation to real dimensions of the glass sheet on which the rigid spacer frame is to be applied, possibly correcting anomalies found by handling with remote manual control of the lower references, vertical references and of the movable support.

13. An apparatus for the construction and application of a rigid spacer frame for insulating glass, the apparatus comprising a movable support adapted to be moved in a vertical direction between a lowered assembly start position, and a raised assembly end position, said movable support being arranged with references for segments of the rigid spacer frame, said apparatus further comprising a warehouse adapted for storage of the segments on whose sides intended in use to be facing glass sheets a butyl sealant has been applied.

14. The apparatus of claim 13, wherein the warehouse is arranged with a horizontal or vertical rack, arranged with separating pegs of non-stick material, said separating pegs being adapted to avoid contact and accidental adhesion between the segments.

15. The apparatus of claim 13, wherein said movable support comprises support elements and movable pegs adapted to be moved between a first position in which the movable pegs do not allow a segment to slide from the support elements towards a support surface of the apparatus adapted to support a glass sheet and a second position in which the movable pegs allow the segment to slide from the support elements towards the support surface.

16. The apparatus of claim 15, wherein said support elements have a support position substantially perpendicular to said support surface.

17. The apparatus of claim 13, wherein the apparatus comprises a row of lower references for said rigid spacer frame, and lower pegs movable between a first position in which the lower pegs do not allow a sliding of the rigid spacer frame towards a support surface of the apparatus adapted to support a glass sheet and a second position in which the lower pegs allow the sliding of the rigid spacer frame towards the support surface.

18. The apparatus of claim 13, wherein the apparatus comprises vertical references and lower references for said rigid spacer frame adapted to be positioned with respect to an outer edge of a glass sheet arranged on a support surface of the apparatus so as to define a determined secondary sealing depth.

19. The apparatus of claim 18, further comprising automatic handling means for said vertical references and/or lower references, said automatic handling means being operatively connected to a control unit adapted for interaction with an operator.

20. The apparatus of claim 13, further comprising a machine for depositing butyl, comprising:
a cutting device for custom cutting an exact length of a protective film to be applied based on a size of a segment being processed;
a pair of opposed rollers adapted to position and adhere the protective film to the butyl; and
at least one reel of the protective film.
